(19) United States
(12) Patent Application Publication
(10) Pub. No.: US 2013/0183574 A1
(43) Pub. Date: Jul. 18, 2013

(54) BATTERY SYSTEM

(71) Applicant: Yasuhiro Asai, Kasai-shi (JP)

(72) Inventor: Yasuhiro Asai, Kasai-shi (JP)

(21) Appl. No.: 13/822,811

(22) PCT Filed: Sep. 27, 2011
(86) PCT No.: PCT/JP2011/072127

§ 371 Date: Mar. 13, 2013

(30) Foreign Application Priority Data
Sep. 30, 2010 (JP) 2010-223089

(51) Int. Cl. H01M 2/20

(52) U.S. Cl. CPC H01M 2/202
USPC 429/159

(57) ABSTRACT

A battery system includes battery cells, metal plates, and welding rings. The battery cell includes terminal rods. The battery cells are connected to each other through the metal plates. The welding rings are arranged on the metal plates, and have insertion holes into which the terminal rods are inserted. The surface of the insertion hole is welded to the terminal rod. The periphery of the welding ring is welded to the metal plate after the terminal rod is inserted into the insertion hole. The terminal rods are electrically connected to the metal plates through the welding rings. The terminal rod and/or the welding ring includes a stopper that temporarily holds the welding ring at a predetermined position with the welding ring being connected to the terminal rod. The temporarily held position is the position where the periphery of the welding ring is in contact with the metal plate.

### BACKGROUND OF THE INVENTION

1. Technical Field

The present invention relates to a battery system including a plurality of battery cells that are connected to each other through metal plates, and in particular to a battery system suitable for power supply for a motor that can drive electric vehicles such as hybrid car, fuel-cell car, electric car and electric motorcycle.

2. Description of the Related Art

In the case where a battery system includes a number of battery cells that are connected to each other in series, the output voltage of the battery system can be high. On the other hand, in the case where a battery system includes a number of battery cells that are connected to each other in parallel, the battery system can be charged/discharged at a large current rate. In large current, high output battery systems that can be used as power supply for an electric motor for driving a car, a plurality of battery cells are connected to each other in series so that the output voltage can be high. These batteries to be used for this type of application are charged/discharged at a large current rate. Accordingly, the plurality of battery cells are connected to each other through metal plates

See Japanese Laid-Open Patent Publication No. JP H05-343,105 A

In the battery system disclosed in JP H05-343,105 A, the ends of the metal plates are fastened to the terminal rods of battery cells through nuts. That is, the terminal rod is inserted into a through hole of the metal plate, and the nut is screwed onto the threaded part of the terminal rod so that the metal plate is fastened to the electrode rod. In this battery system, in order to stably electrically connect the terminal rod to the metal plate with the electrical resistance between them being low, it is necessary to screw the nut at high torque. However, if the nut is screwed at high torque, a large force will be exerted on the terminal rod. Such a large force exerted on the terminal rod may cause the failure of a part that couples the terminal rod to the exterior container of a battery. If the nut is screwed at low torque in order to prevent the failure of the terminal rod, this may cause a problem that the metal plate cannot be stably electrically connected to the terminal rod with the electrical resistance between them being low.

This problem can be solved by welding the metal plate to the terminal rod by laser welding or the like. In the laser welding, the connection part between the terminal rod and the metal plate is irradiated with laser beam so that both the terminal rod and the metal plate are melted and welded to each other by the energy of the laser beam. Laser welding brings electrical connection between the terminal rod and the metal plate without exerting undesirable forces on the terminal rod or the metal plate. In the laser welding, both the terminal rod and the metal plate are melted so that they are connected to each other through the melted metals. Accordingly, if a gap is provided between the terminal rod and the metal plate, they cannot be stably welded to each other.

In the construction where the metal plate has a through hole that receives the terminal rod, in principle, the outer periphery of the terminal rod can be arranged close to the inner periphery of the through hole of the metal plate without gap. However, in this construction, it is necessary to accurately realize the connection position between the metal plate and the terminal rod, and to accurately form the interior shape of the through hole of the metal plate that matches with the exterior shape of the terminal rod. For this reason, there is a problem that it is difficult to smoothly insert the terminal rod into the through hole.

This problem can be solved by the construction where a welding ring is arranged on the surface of the metal plate with the terminal rod being inserted into the metal plate so that the terminal rod is inserted into an insertion hole that is provided in the welding ring. When the terminal rod is inserted into the welding ring, the insertion hole can be arranged close to the outer periphery of the terminal rod without gap so that the outer periphery can be arranged close to the metal plate. Thus, the inner peripheral surface of the insertion hole of the welding ring can be welded to the terminal rod by the laser welding, while the outer periphery of the welding ring can be welded to the metal plate by the laser welding. As a result, the terminal rod can be electrically connected to the metal plate through the welding ring.

According to this construction, although the metal plate has a large through hole into which the terminal rod smoothly can be inserted so that the terminal rod can be smoothly inserted into the metal plate, the metal plate can be reliably electrically connected to the terminal rod. However, in this construction, in order to reliably weld the welding ring to the metal plate, it is necessary to bring the outer periphery of the welding ring in tight contact with the surface of the metal plate in the welding process. The reason is that the outer periphery of the welding ring cannot be reliably and stably weld to the metal plate if a gap is provided between them.

It is an object of the present invention to provide a battery system that can easily and reliably bring a welding ring in contact with the surface of a metal plate without gap, and reliably weld the welding ring to the metal plate whereby stably and firmly connecting the terminal rod to the metal plate through the welding ring with the electrical resistance between them being low.

### SUMMARY OF THE INVENTION

A battery system according to the present invention includes a plurality of battery cells, metal plates, and welding rings. The plurality of battery cells includes terminal rods. The terminal rods of the battery cell are inserted into the metal plates. The battery cells are connected to each other in series and/or in parallel through the metal plates. The welding rings are arranged on the metal plates, and have insertion holes into which the terminal rods are inserted. After the terminal rod is inserted into the insertion hole, the inner peripheral surface of the insertion hole is welded to the terminal rod, while the outer periphery of the welding ring is welded to the metal plate. The terminal rods are electrically connected to the metal plates through the welding rings. The terminal rod and/or the welding ring includes a stopper that temporarily holds the welding ring at a predetermined position with the welding ring being connected to the terminal rod. The temporarily held position of the stopper is the position where the outer periphery of the welding ring is brought in contact with the surface of the metal plate.

The battery system has a feature that the outer periphery of the welding ring can be easily and reliably brought in contact with the surface of the metal plate without gap so that the welding ring can be reliably welded to the metal plate, which in turn can stably and firmly connect the terminal rod to the metal plate through the welding ring with the electrical resistance between them being low. The reason is that the stopper temporarily holds the welding ring on the terminal rod so that the outer periphery of the welding ring is in contact with the surface of the metal plate. In the case where the welding ring and the metal plate are in contact with each other, both the welding ring and the metal plate can be melted and reliably welded to each other in the connection part.

In the battery system according to the present invention, each of the metal plates can have a plurality of through holes into which the terminal rods of the plurality of battery cells are inserted. Tight and loose fitting through holes and are provided as the plurality of through holes. The tight fitting through hole has a shape that matches with the outer periphery of the terminal rod. The loose fitting through hole has a shape larger than the exterior shape of the terminal rod. In addition, the terminal rod that is inserted into the tight fitting through hole is directly welded and electrically connected to the metal plate, and the terminal rod that is inserted into the loose fitting through hole is electrically connected to the metal plate through the welding ring.

The thus-constructed battery system has the feature that, since the loose fitting through hole allows dimensional deviation of the battery cell or the metal plate, the terminal rod can be smoothly inserted into the through hole of the metal plate while the terminal rod can be electrically reliably connected to the metal plate through the welding ring. The treason is that the insertion of the terminal rod into the loose fitting through hole allows dimensional deviation of the battery cell or the metal plate while the welding ring closes the gap between the metal plate and the terminal rod after the terminal rod is inserted into the loose fitting through hole so that the welding ring can be welded to the terminal rod and the metal plate without gap with the terminal rod and the metal plate being electrically connected to each other.

In the battery system according to the present invention, each of the metal plates can have one tight fitting through hole, and one or more loose fitting through holes.

According to the thus-constructed battery system, the battery cells can be connected to each other in series and/or in parallel through the metal plates.

In the battery system according to the present invention, the loose fitting through hole can be an elongated hole.

According to the thus-constructed battery system, since the elongated hole allows dimensional deviation of the interval between the terminal rods of the battery cells adjacent to each other, the terminal rods can be smoothly inserted into the through holes of the metal plates.

In the battery system according to the present invention, the stopper is an interlocking protrusion that is arranged on and protrudes from the surface of the terminal rod. The welding ring can be sandwiched between the metal plate and the interlocking protrusion so that the welding ring can be held at the predetermined position.

According to the thus-constructed battery system, although the stopper can be simple, when the terminal rod is inserted into the welding ring, the terminal rod and the welding ring can arranged at the predetermined position.

In the battery system according to the present invention, the welding ring can include an interlocking ring part, a tight fitting ring part, and an outer periphery ring part. The terminal rod is inserted into the interlocking ring part. The tight fitting ring part is coupled to the interlock ring part, and arranged on the end side of the terminal rod relative to the interlock ring part. The tight fitting ring part has the insertion hole that matches with the terminal rod, and is to be welded to the terminal rod. The outer periphery ring part is coupled to the tight fitting and interlock ring parts. The outer periphery of the outer periphery ring part is be welded to the metal plate.

According to the thus-constructed battery system, since the tight fitting ring part having the small insertion hole can interlock with the terminal rod, the interlocking ring part allows the welding ring to interlock with the terminal rod with the inner peripheral surface of the insertion hole being brought close to the surface of the terminal rod. The interlocking ring part has an interior shape that allows smooth insertion of the terminal rod into the welding ring. Accordingly, the thus-constructed battery system has a feature that the terminal rod can be smoothly inserted into the welding ring and can position the welding ring at predetermined position.

In the battery system according to the present invention, the terminal rod can include the interlocking protrusion that interlocks with the interlocking ring part of the welding ring.

The thus-constructed battery system has a feature that the simple stopper allows smooth insertion of the terminal rod into the welding ring, and can position the welding ring at the predetermined position.

In the battery system according to the present invention, the terminal rod can include an interlocking recessed part that interlocks with the interlocking ring part of the welding ring.

In the thus-constructed battery system has a feature that, although the terminal rod includes the very simple stopper, the insertion hole of the tight fitting ring part can have a shape that allows the inner peripheral surface of the insertion hole can be brought close to the surface of the terminal rod so that the tight fitting ring part can be reliably welded to the terminal rod.

In the battery system according to the present invention, the welding ring can include a curved part having an outer peripheral edge to be arranged close to the surface of the metal plate.

According to the thus-constructed battery system, since the outer peripheral edge of the welding ring can be brought in tight contact with the surface of the metal plate when the welding ring interlocks with the stopper, the welding ring can be reliably welded to the metal plate.

In the battery system according to the present invention, when the welding ring is held at the predetermined position on the terminal rod by the stopper, the outer peripheral edge of the curved part is elastically pressed toward the surface of the metal plate.

According to the thus-constructed battery system, since the outer peripheral edge of the curved part of the welding ring can be elastically pressed toward the surface of the metal plate, the outer peripheral edge can be brought in tight contact with the surface of the metal plate. According to this construction, the outer peripheral edge can be brought in tight contact with the surface of the metal plate without close tolerance machining for position the welding ring at the predetermined position of the terminal rod. As a result, the welding ring can be stably welded to the metal plate. The reason is that the elastic deformation of the curved part brings the outer peripheral edge in tight contact with the surface of the metal plate.

In the battery system according to the present invention, the welding ring can have a cut-out part that extends in a radial direction of the ring.

According to the thus-constructed battery system, the terminal rod can be smoothly inserted into the welding ring. The reason is that the cut-out part allows the interior shape of the insertion hole of the welding ring to expand when the terminal rod is inserted into the welding ring.

In the battery system according to the present invention, the interior shape of the insertion hole of the welding ring can be smaller than the exterior shape of the terminal rod. The welding ring has a plurality of cut lines that extend from the insertion hole toward the outer periphery but do not reach the outer peripheral edge so that elastic parts are formed between the cut lines whereby forming the stopper. When the terminal rod is inserted into the welding ring, the elastic parts elastically engage with the surface of the terminal rod so that the welding ring is temporarily held at the temporarily held position on the terminal rod.

According to the thus-constructed battery system, since the welding ring can be temporarily held at the position where the outer periphery of the welding ring is brought in contact with the surface of the metal plate when the terminal rod is inserted into the welding ring, the terminal rod can be simply, easily and smoothly inserted into the welding ring so that the outer periphery of the welding ring is brought in contact with the surface of the metal plate. The reason to allow the terminal rod to smoothly receive the welding ring is that the elastic part can be elastically deformed in a direction that allows smooth insertion of the terminal rod into the welding ring when the terminal rod is inserted into the welding ring. In addition, when the terminal rod is inserted to the position where the outer periphery of the welding ring is in contact with the metal plate, the welding ring is temporarily held whereby preventing the welding ring from moving outward. As a result, the welding can be held in the contact state whereby keeping the contact of the outer periphery of the welding ring with the surface of the metal plate.

### BRIEF DESCRIPTION OF THE DRAWINGS

FIG. 1: Perspective view of a battery system according to an embodiment of the present invention.

FIG. 2: Exploded perspective view of the battery system shown in FIG. 1.

FIG. 3: Exploded perspective view showing the side-by-side arrangement of battery cells and an electrically insulating spacer of the battery system shown in FIG. 1.

FIG. 4: Vertical cross-sectional view of the battery cell.

FIG. 5: Enlarged perspective view showing the connection between terminal rods and a metal plate of the battery system shown in FIG. 1.

FIG. 6: Enlarged perspective view showing the process of connection between the adjacent terminal rods through the metal plate.

FIG. 7: Enlarged perspective view showing the process of connection between the adjacent terminal rods through the metal plate.

FIG. 8: Enlarged cross-sectional view showing the connection structure between the terminal rods and the metal plate shown in FIG. 5.

FIG. 9: Enlarged cross-sectional view of a battery system according to another embodiment of the present invention.

FIG. 10: Exploded perspective view of the battery system shown in FIG. 9.

FIG. 11: Enlarged cross-sectional view of a battery system according to another embodiment of the present invention.

FIG. 12: Exploded perspective view of the battery system shown in FIG. 11.

FIG. 13: Enlarged cross-sectional view of a battery system according to another embodiment of the present invention.

FIG. 14: Exploded perspective view of the battery system shown in FIG. 13.

FIG. 15: Enlarged cross-sectional view of a battery system according to another embodiment of the present invention.

FIG. 16: Exploded perspective view of the battery system shown in FIG. 15.

FIG. 17: Enlarged cross-sectional view of a battery system according to another embodiment of the present invention.

FIG. 18: Exploded perspective view of the battery system shown in FIG. 17.

### DETAILED DESCRIPTION OF THE INVENTION

The following description will describe embodiments according to the present invention with reference to the drawings. It should be appreciated, however, that the embodiments described below are illustrations of a battery system to give a concrete form to technical ideas of the invention, and a battery system of the invention is not specifically limited to description below. In this specification, reference numerals corresponding to components illustrated in the embodiments are added in “Claims” and “SUMMARY OF THE INVENTION” to aid understanding of claims. However, it should be appreciated that the members shown in claims attached hereto are not specifically limited to members in the embodiments.

A battery system can be mainly installed on an electric vehicle such as hybrid car and electric car, and is used as a power supply which supplies electric power to an electric motor of the electric vehicle whereby driving the electric vehicle.

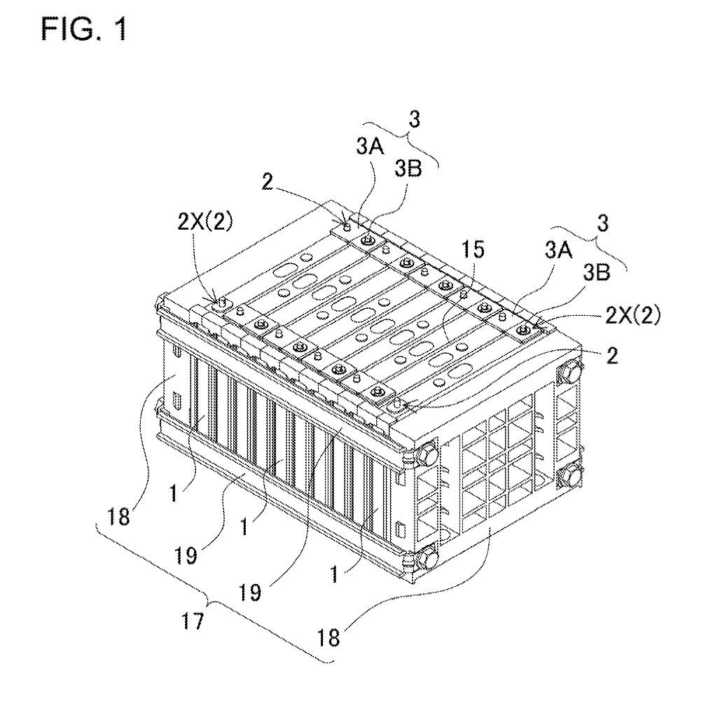

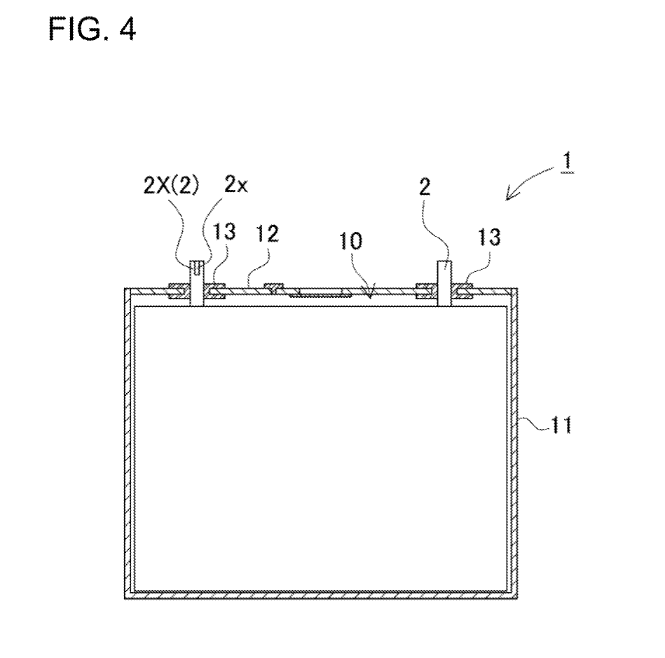

In a battery system shown in FIGS. 1 to 3 includes a plurality of battery cells 1. The battery cells are electrically insulated from each other, and fastened to each other with the battery cells being arranged side by side. The battery cell 1 is a rectangular battery cell. More specifically, the battery cell 1 is a rectangular battery cell of lithium-ion battery. It will be appreciated that the battery cells in the battery system according to the present invention are limited to neither rectangular battery cells nor lithium-ion rechargeable batteries. Any rechargeable batteries (e.g., nickel metal hydride batteries) can be used as the battery cells. As shown in FIG. 4, the rectangular battery cell includes electrode members 10 of positive/negative electrode plates that overlap each other. After the electrode members are accommodated in an exterior container 11, the opening of the exterior container 11 is airtightly sealed by a sealing plate 12. The illustrated exterior container 11 has a rectangular box shape that has a top opening and a closed bottom. The top opening of the exterior container is airtightly closed by the sealing plate 12.

The exterior container 11 is formed by subjecting a metal plate (e.g., aluminum plate) to deep drawing. The surface of the exterior container has electrical conductivity. The battery cells 1 to be arranged side by side are formed in a thin rectangular box shape. The sealing plate 12 is formed of a metal plate the material of which is same as the exterior container 11 (e.g., aluminum plate). Positive/negative terminal rods 2 are secured to the both side parts of the sealing plate 12. Electrically-insulating members 13 are interposed between the terminal rods 13 and the sealing plate. The positive/negative terminal rods 2 are connected to the positive/negative electrode plates, which are accommodated in the exterior container. The exterior container 11 of the rechargeable lithium-ion battery is not connected to the electrodes. On the other hand, the exterior container 11 is connected to the electrode plates through electrolyte. Accordingly, the potential of the exterior container will be an intermediate potential between the positive/negative electrode plates 10. It will be appreciated that one of the terminal rods of the battery cell may be connected to the exterior container through a lead. In this case, the terminal rods, which are connected to the exterior container, can be fastened to the sealing plate without the electrically-insulating members.

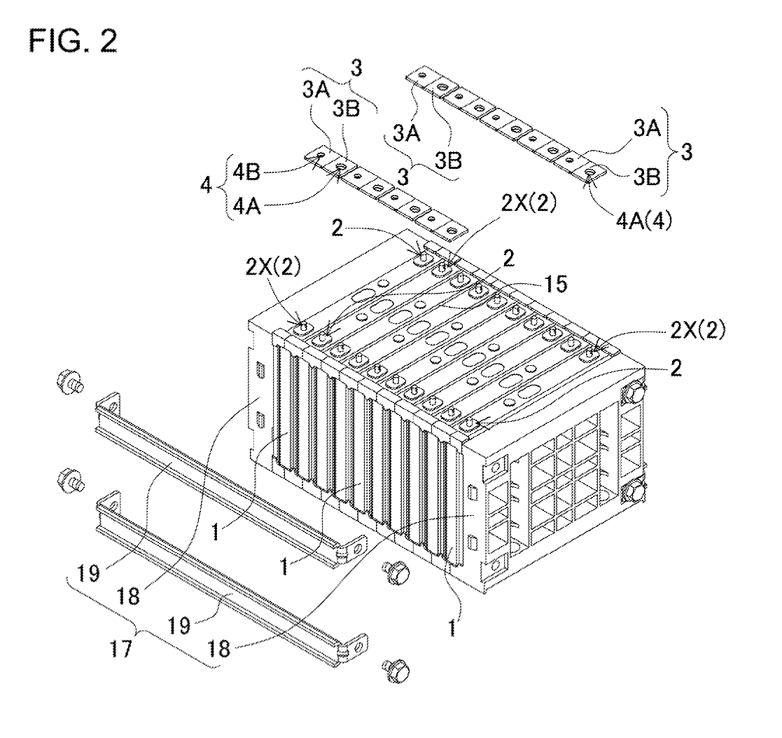

The plurality of battery cells 1 are arranged side by side so that the battery system has a rectangular block shape. When the battery cells 1 are arranged side by side, the surfaces (the sealing plates 12) of the battery cells with the terminal rods 2 are arranged coplanar with each other. As a result, the battery system can have a rectangular block shape. In the battery system shown in FIGS. 1 and 2, the terminal rods 2 are located on the upper surface of the block. When the battery cells of the battery system are arranged side by side, the positive/negative terminal rods 2 on the both end parts of the sealing plates 12 are flipped from side to side. In this battery system, the illustrated terminal rods 2 that are arranged adjacent to each other on each side of the block are connected to each other through the metal plate 3 so that the battery cells 1 are connected to each other in series. The both ends of the metal plate 3 are connected to the positive/negative terminal rods 2 so that the battery cell 1 are connected to each other in series. In the illustrated battery system, the battery cells 1 are connected to each other in series so that the output voltage of the battery system can be high. It will be appreciated that the battery cells of the battery system according to the present invention can be connected to each other in series and in parallel so that both the output voltage and the output current of the battery system can be high.

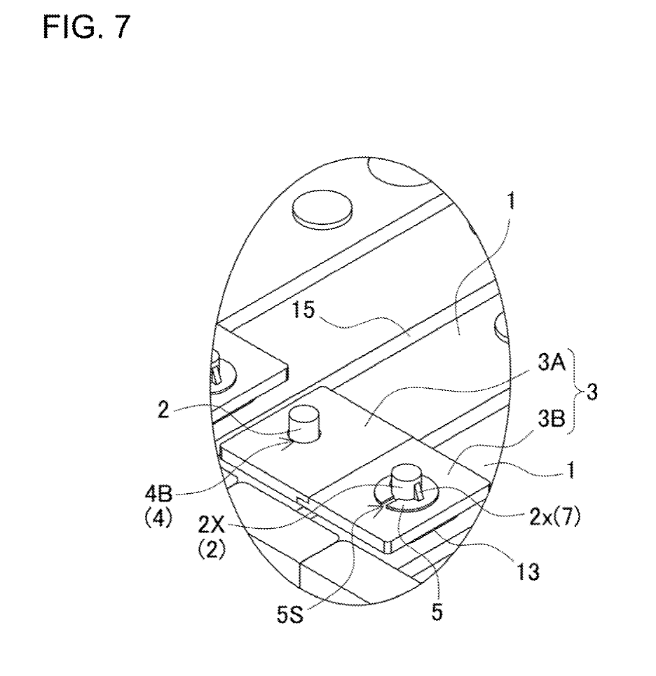

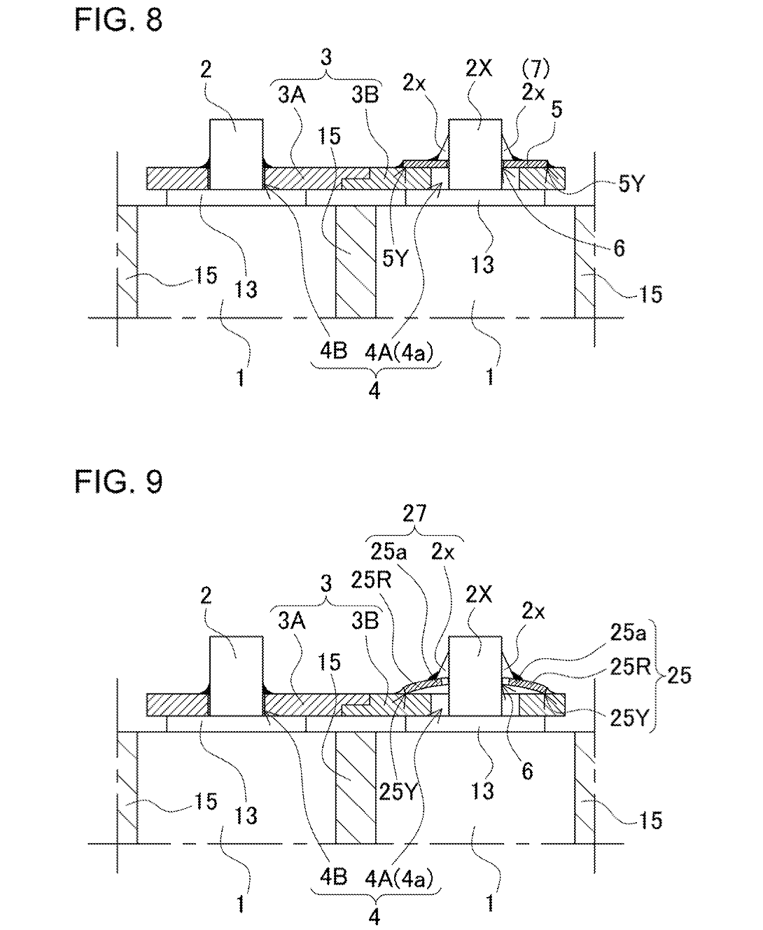

As shown in FIGS. 4 to 8, the terminal rods 2 are fastened to the sealing plate 12 with the electrically insulating materials 13 being interposed between the terminal rods and the sealing plate. The electrically insulating material 13 serves as a flange portion onto which the metal plate 3 is placed. The flange portion is located in the lower part of the terminal rod. The terminal rod 2 includes a columnar part that protrudes from the flange portion, and receives the metal plate 3 and a welding ring 5. Although the illustrated terminal rod 2 has a circular cylindrical shape, the terminal rod is not limited to a circular cylindrical shape. The terminal rod can have a polygonal prism shape or an elliptic cylindrical shape.

In the battery system shown in FIGS. 1 and 2, the battery cells 1 are connected to each other in series through the metal plates 3, which are connected to the terminal rods 2. In the illustrated battery system, the battery cells are connected to each other in series through the metal plates 3. Alternatively, in the battery system, the battery cells can be connected to each other in parallel through the metal plates.

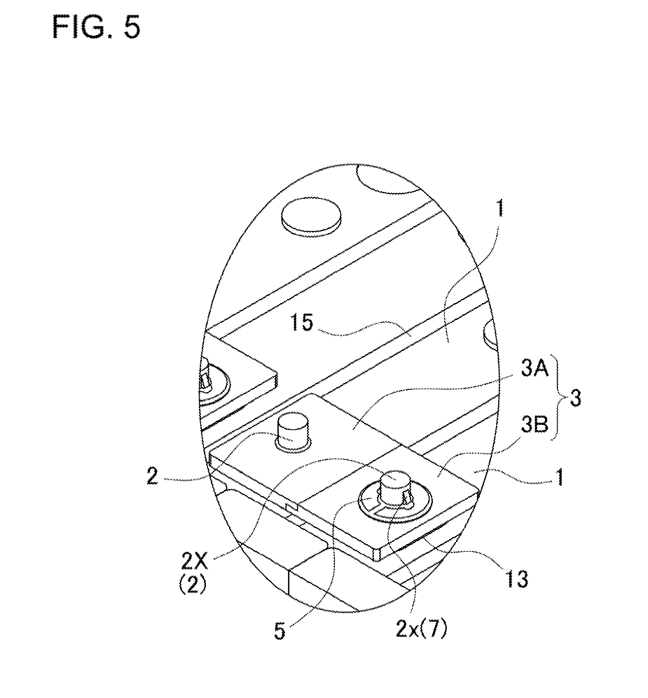

FIGS. 5 to 18 show the electrical connection between the terminal rod 2 of the battery cell 1 and the metal plate 3, and welding ring 5, 25, 35, 45, 55 or 65. The illustrated terminal rod 2 is electrically connected to the metal plate 3 through the welding ring 5, 25, 35, 45, 55 or 65 by welding. The welding rings 5, 25, 35, 45, 55 and 65 are formed of a metal plate that can be welded to the terminal rod 2 and the metal plate 3. The welding rings 5, 25, 35, 45, 55 and 65 are preferably formed of a metal plate the material of which is same as the terminal rod 2 and the metal plate 3. The welding rings 5, 25, 35, 45, 55 and 65 have an insertion hole 6 in the center of the welding ring. The terminal rod 2 can be inserted into the insertion hole so that the welding ring can be welded to the terminal rod 2. The interior shape of the insertion hole 6 matches with the exterior shape of the terminal rod 2 so that the welding ring can be in contact with the outer peripheral surface of the terminal rod 2 without gap when the terminal rod is inserted into the insertion hole. The inner peripheral surface of the insertion hole 6 of the welding ring 5, 25, 35, 45, 55 or 65 is welded to the terminal rod 2, while the outer peripheral surface of the welding ring is welded to the metal plate 3 so that the terminal rod 3 is electrically connected to the metal plate 3. The welding ring 5, 25, 35, 45, 55 or 65 is welded to the terminal rod 2 by irradiation of laser beam on the connection part between the welding ring and the terminal rod 2, and is welded to the metal plate 3 by irradiation of laser beam on the connection part between the welding ring and the metal plate 3.

The following description describes embodiments in which the welding rings 5, 25, 35, 45, 55 or 65 are welded to the terminal rods 2 and the metal plates 3 by irradiation of laser beam. It will be appreciated that the welding ring can be welded to the terminal rod or the metal plate by irradiation of energy beam such as electron beam instead of the laser beam. Alternatively, the welding ring can be welded to the terminal rod by welding current flowing between the welding ring and the terminal rod, and welded to the metal plate by welding current flowing between the welding ring and the metal plate, since the welding ring is in contact the terminal rod and the metal plate.

As for the welding ring 5, 25, 35, 45, 55 or 65, and the terminal rod 2 shown in FIGS. 5 to 18, the terminal rod 2 and/or the welding ring 5, 25, 35, 45, 55 or 65 includes a stopper 7, 27, 37, 47, 57 or 67 that temporarily holds the welding ring 5, 25, 35, 45, 55 or 65 at a predetermined position with the welding ring being connected to the terminal rod 2. The temporarily held position of the stopper 7, 27, 37, 47, 57 or 67 for temporarily holding the welding ring 5, 25, 35, 45, 55 or 65 whereby preventing the welding ring from moving outward is the position where the outer periphery of the welding ring 5, 25, 35, 45, 55 or 65 is brought in contact with the surface of the metal plate 3.

In the battery cell 1 shown in FIGS. 5 to 8, a terminal rod 2X includes interlocking protrusions 2x for forming interlocking structures. The interlocking protrusion 2x protrudes from the surface of the terminal rod 2X. The illustrated interlocking protrusion 2x has an inclined surface the protrusion amount of which gradually increases in the insertion direction of the welding ring 5 so that the welding ring 5 can be smoothly inserted. In order that the interlocking protrusions 2x can temporarily hold the welding ring 5 with the outer periphery of the welding ring 5 is entirely brought in contact with the metal plate 3, a plurality of interlocking protrusions 2x are arranged on the outer peripheral surface of the terminal rod 2X. The welding ring 5 is sandwiched between the interlocking protrusions 2x the metal plates 3 so that the interlocking protrusions temporarily hold the welding ring. The temporarily held position of the interlocking protrusions 2x for temporarily holding the welding ring 5 is the position where the outer periphery of the welding ring 5 is brought in contact with the metal plate 3.

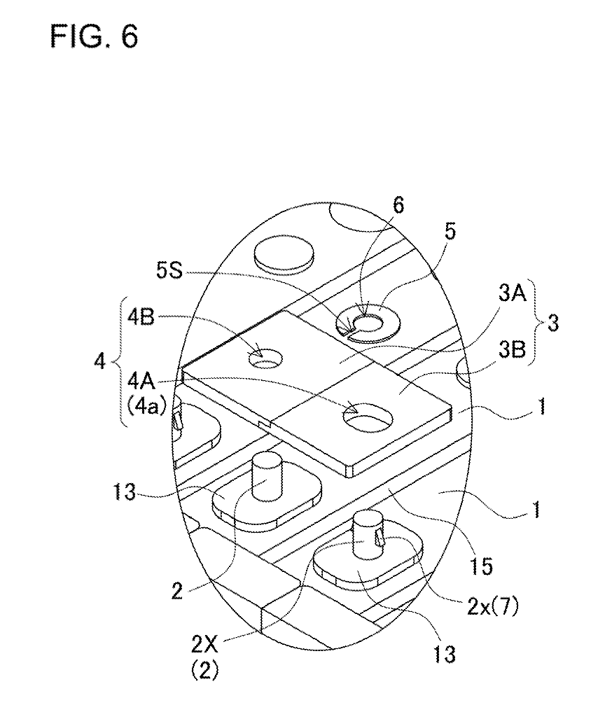

When the terminal rod is inserted into the welding ring 5, the welding ring 5 passes the interlocking protrusions 2x and is held at the temporarily held position. The welding ring 5 shown in FIG. 6 has a cut-out part that extends in a radial direction of the ring. Accordingly, the welding ring can easily elastically deform. When the welding ring 5 passes the interlocking protrusions 2x, a cut-out part 5S that extends in a radial direction of the ring can expand so that the interior shape of the insertion hole 6 can expand. For this reason, the terminal rod 2X with the interlocking protrusions 2x can be smoothly inserted into the insertion hole 6 of the welding ring 5. The cut-out part 5S of the welding ring 5 can expand so that the welding ring itself can elastically deform. Thus, when the welding ring passes the interlocking protrusions 2x, the insertion hole 6 will expand. It will be appreciated that the welding ring does not necessarily have a cut-out part that extends in a radial direction of the ring. The welding ring may elastically deform to expand so that the terminal rod with the interlocking protrusions can be inserted into the welding ring.

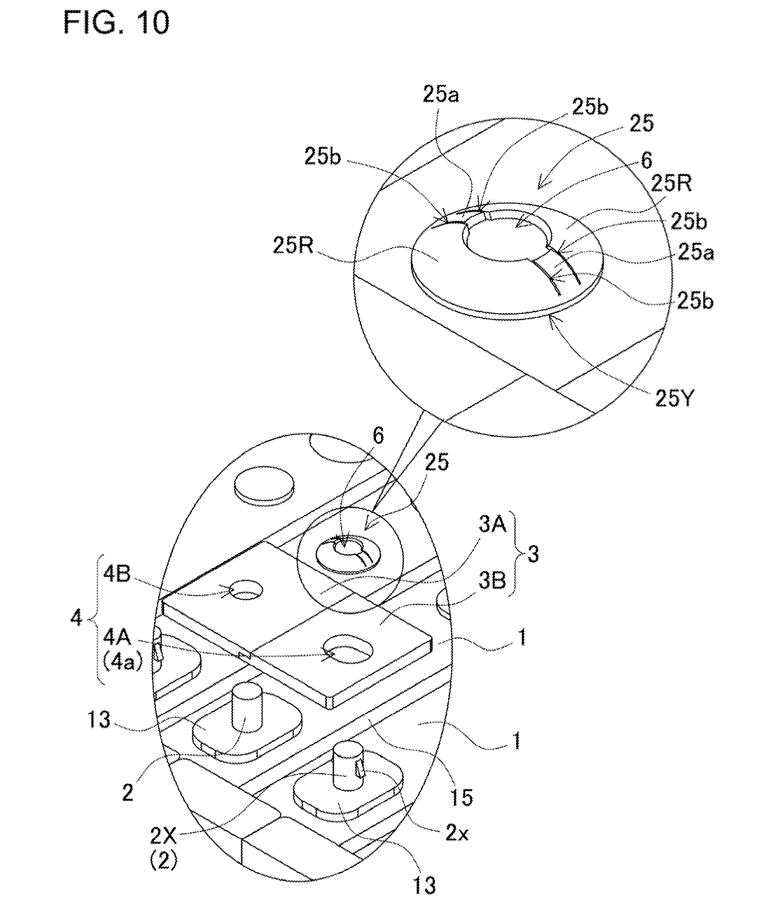

The welding ring can be constructed as shown in FIGS. 9 and 10. The welding ring 25 has pairs of slits 25b that are arranged along the lines corresponding to the both sides of the area where welding ring passes the interlocking protrusion 2x. Thus, an elastic part 25a is formed between each pair of slits 25b. The welding ring 25 is formed of an elastically deformable metal plate. When the welding ring passes the interlocking protrusion 2x, the elastic part 25a deforms and passes the interlocking protrusion. Thus, the elastic parts 25a serve as the stopper 27, which temporarily holds the welding ring 25 at the predetermined position on the terminal rod 2X when the elastic parts interlock with the interlocking protrusions 2x. The elastic parts 25a of the illustrated welding ring 25 have a shorter radial length so that the elastic parts can easily pass the interlocking protrusions 2x. The illustrated welding ring 25 includes a curved part 25R having an outer peripheral edge 25Y to be arranged close to the surface of the metal plate 3. The illustrated welding ring 25 has a convex shape. The central part of the entire shape of the welding ring protrudes upward. Thus, the curved part 25R is provided between the elastic part 25a and the outer peripheral edge 25Y. In this welding ring 25, when the terminal rod 2X is inserted into the insertion hole 6, the elastic parts 25a and the curved part 25R elastically deform so that the elastic parts 25a can easily pass the interlocking protrusion 2x. In addition, when the elastic parts 25a interlock with the interlocking protrusions 2x, in other words, when the welding ring 25 interlocks with the stopper 27 and is held at the predetermined position on the terminal rod 2X, the outer peripheral edge 25Y of curved part 25R can be elastically pressed toward the surface of the metal plate 3.

Also, the welding ring shown in FIGS. 5 to 8 is formed of an elastically deformable metal plate, and includes a curved part having an outer peripheral edge to be arranged close to the surface of the metal plate. Also, when the welding ring is held at the predetermined position on the terminal rod, the outer peripheral edge of the curved part can be elastically pressed toward the surface of the metal plate.

When the terminal rod 2X is inserted into the through hole 4, the stopper 7 or 27 shown in FIGS. 5 to 10 temporarily holds the welding rings 5 or 25 on the surface of the metal plate 3, which is placed on the flange portion. After the terminal rod 2X is inserted into the insertion hole 6 of the welding ring 5 or 25, when the welding ring is pushed toward the metal plate 3, the welding ring can be temporarily held with the outer periphery of the welding ring being in contact with the surface of the metal plate 3. At the temporarily held position, the welding ring 5 or 25 is sandwiched between the interlocking protrusions 2x and the metal plate 3. Thus, the interlocking protrusions 2x temporarily holds the welding ring on the terminal rod 2X whereby preventing the welding ring from moving outward. In this temporarily held state, the welding ring 5 or 25 is welded to the terminal rod 2X by irradiation of laser beam on the connection part between the inner peripheral surface of the insertion hole and the outer peripheral surface of the terminal rod 2, and is welded to the metal plate 3 by irradiation of laser beam on the connection part between the outer peripheral edge 5Y or 25Y and the metal plate 3.

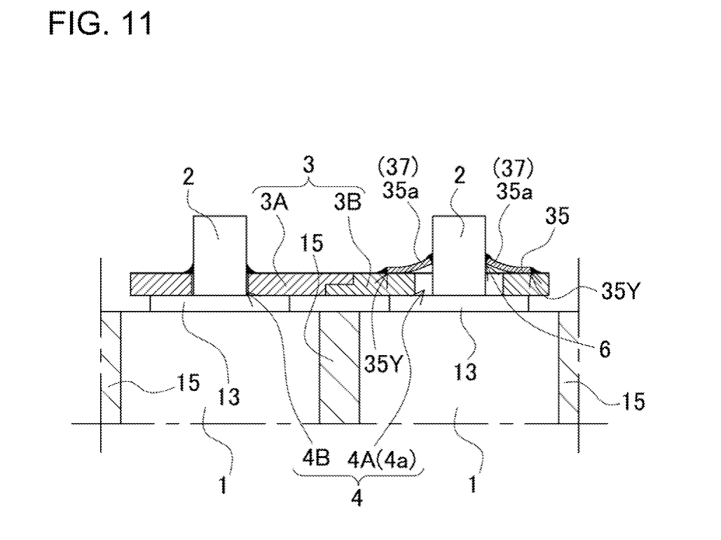

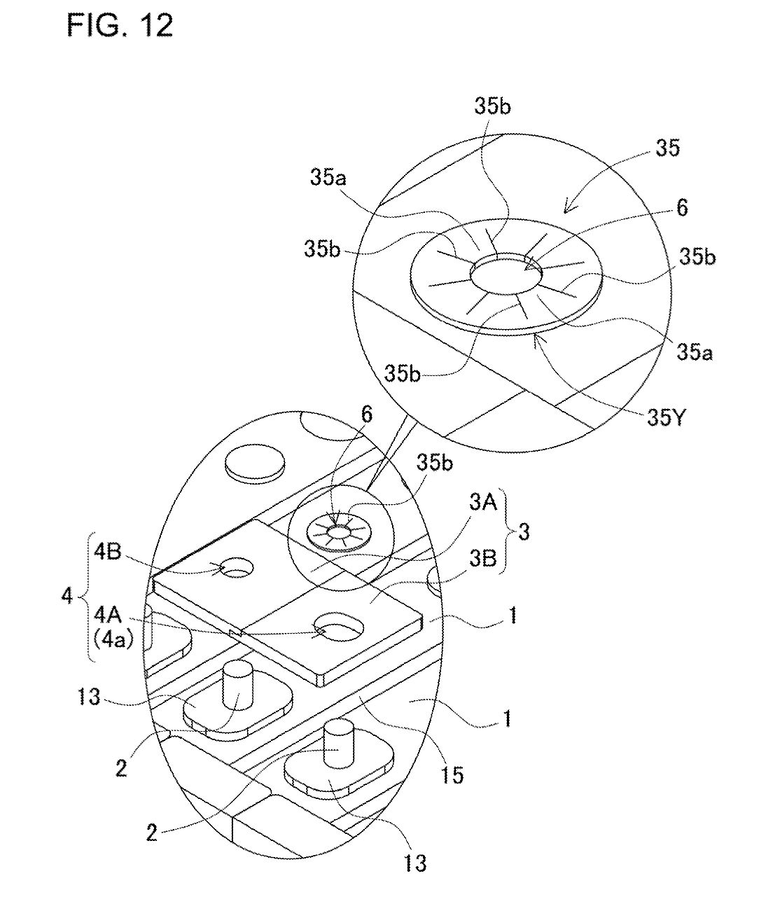

FIGS. 11 and 12 show the welding ring 35, which includes the stopper 37. The welding ring 35 is formed of an elastically deformable metal plate. The interior shape of the insertion hole 6 of this welding ring is dimensioned smaller than the exterior shape of the terminal rod 2. In order to insert the terminal rod 2 into the small insertion hole 6, this welding ring has a plurality of cut lines 35b that extend from the insertion hole 6 toward the outer periphery but do not reach the outer peripheral edge 35Y so that elastic parts 35a are formed between the cut lines 35b. Thus, the elastic parts 35a serve as the stopper 37. When the terminal rod 2 that does not have the interlocking protrusion is inserted into this welding ring 35, the welding ring can be temporarily held at the position where the outer periphery of the welding ring is brought in contact with the metal plate 3.

The welding ring 35 has the insertion hole 6 smaller than the terminal rod 2. Accordingly, when the terminal rod 2 is inserted into the welding ring, as shown in FIG. 12, the elastic part 35A will elastically deform. Thus, the shape of the insertion hole 6 can expand to the exterior shape of the terminal rod 2. The elastically deformable elastic parts 35A elastically engage with the surface of the terminal rod 2 so that the welding ring 35 can be temporarily held at the temporarily held position on the terminal rod 2. When the terminal rod is inserted into the welding ring 35 and reaches the position where the outer periphery of the welding ring is in contact with the surface of the metal plate 3, the elastic parts 35A can temporarily hold the welding ring whereby preventing the welding ring from moving outward. In this temporarily held state, the connection part between the outer peripheral edge 35Y of the welding ring 35 and the metal plate 3 is irradiated with the laser beam so that the welding ring 35 is welded to the metal plate 3. In addition, the welding ring is welded to the terminal rod 2 by irradiation of laser beam on the connection part between the terminal rod 2 and the insertion hole 6 that elastically expands and is in contact with the surface of the terminal rod 2. In the case where the welding ring 35 is used, there is a feature that the terminal rod 2 does not necessarily include the interlocking protrusion but the outer periphery of the welding ring 35 can be arranged at an ideal position where the welding ring is in contact with the metal plate 3 when the terminal rod 2 is inserted into the welding ring 35.

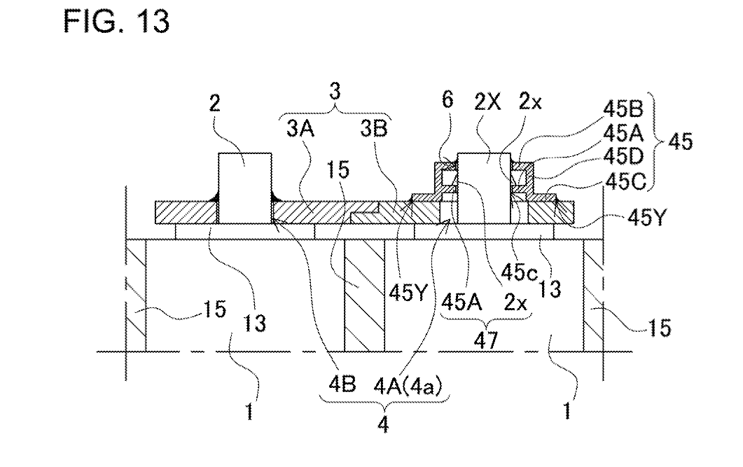

In the terminal rod 2 and the welding ring 45, 55 or 65 shown in FIGS. 13 to 18, the stoppers 47, 57 or 67 is provided in the terminal rod 2 and/or the welding ring 45, 55 or 65. The welding ring 45, 55 or 65 can include an interlocking ring part 45A, 55A or 65A, a tight fitting ring part 45B, 55B or 65B, and an outer periphery ring part 45C, 55C or 65C. The terminal rod 2 is inserted into the interlocking ring part. The tight fitting ring part is coupled to the interlock ring part 45A, 55A or 65A, and arranged on the end side of the terminal rod 2 relative to the interlock ring part 45A, 55A or 65A. The tight fitting ring part has the insertion hole 6 that matches with the terminal rod 2. The inner peripheral surface of the insertion hole 6 is to be welded to the terminal rod 2. The outer periphery ring part is coupled to the interlock ring and tight fitting parts 45A, 55A or 65A, and 45B, 55B or 65B. The outer periphery of the outer periphery ring part is be welded to the metal plate 3.

The tight fitting ring part 45B and the interlocking ring part 45A are coupled to each other through a cylindrical part 45D. In the illustrated welding ring, the tight fitting ring part 45B, 55B or 65B is arranged on the upper end of the cylindrical part 45D, 55D or 65D, while the outer periphery ring part 45C, 55C or 65C is arrange on the lower end of the cylindrical part. In the illustrated welding ring 45, 55 or 65, the interlocking ring part 45A, 55A or 65A is arranged between the outer periphery ring part 45C, 55C or 65C and the tight fitting ring part 45B, 55B or 65B. It will be appreciated that the interlocking ring part can be arranged coplanar with the outer periphery ring part. In the tight fitting ring part 45B, 55B or 65B, the interior shape of the insertion hole 6 matches with the exterior shape of the terminal rod 2 so that the inner peripheral surface of the insertion hole 6 can be brought in contact with the outer peripheral surface of the terminal rod 2 when the welding ring is temporarily held at the temporarily held position.

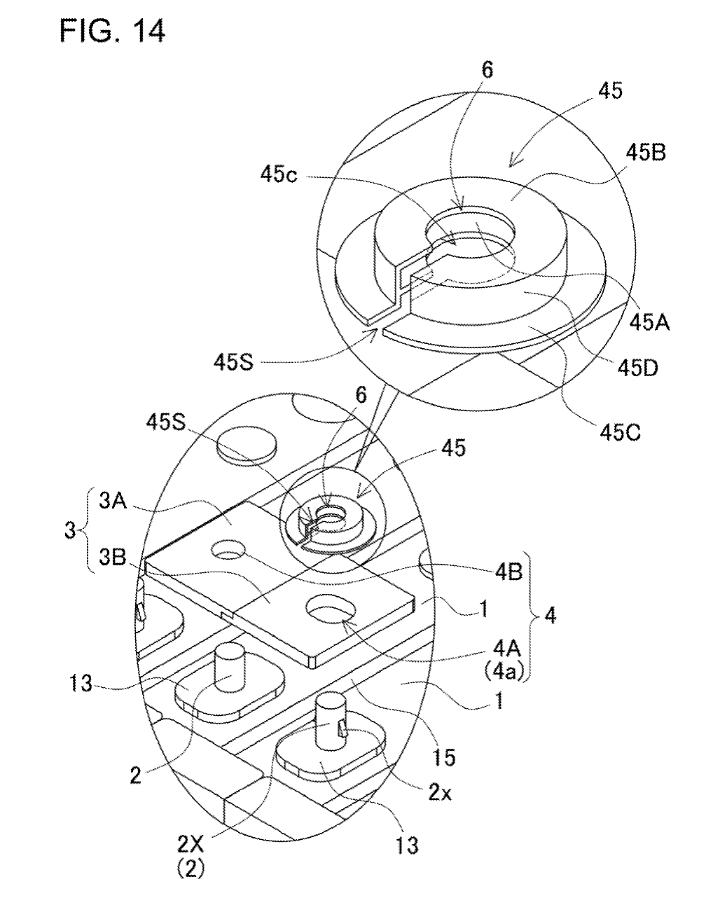

In the welding ring 45 shown in FIGS. 13 and 14, the stopper 47 is constructed of the interlocking ring part 45A and the interlocking protrusions 2x of the terminal rod 2X. The welding ring 45 shown in FIG. 13 has a shape that can guide the interlocking protrusions 2x of the terminal rod 2 to the part between the interlocking ring part 45A and the tight fitting ring part 45B. In order that the interlocking ring part 45A can pass the interlocking protrusion 2x when the terminal rod 2X is inserted into the welding ring 45, the interior shape of a central hole 45c of the interlocking ring part 45A is dimensioned to be larger than the exterior shape of the terminal rod and to interlock with the interlocking protrusions 2x.

The terminal rod 2X shown FIGS. 13 and 14 includes the interlocking protrusions 2x for forming the stopper 47. The interlocking protrusions 2x protrude from the surface of the terminal rod 2X, and interlock with the welding ring 45 at the temporarily held position. Similar to the terminal rod 2X shown in FIGS. 5 to 8, the interlocking protrusion 2x has a shape gradually protrudes in the insertion direction of the welding ring 45. The interlocking ring part 45A can pass the interlocking protrusions 2x when the terminal rod 2X is inserted into the welding ring. Thus, the interlocking protrusions 2x temporarily holds the welding ring at the temporarily held position whereby preventing the welding ring from moving outward. In addition, in order that the interlocking ring part 45A can easily elastically deform, the entire of the welding ring 45 shown in FIG. 14 has a cut-out part 45S that extend in a radial direction of the ring, in other words, the tight fitting ring part 45B, the interlocking ring part 45A, the outer periphery ring part 45C, and the cylindrical part 45D have cut-out parts. When the interlocking ring part 45A passes the interlocking protrusion 2x, the cut-out parts 45S of the welding ring 45 can expand so that the interior shape of central hole 45c of the interlocking ring part 45A can expand. As a result, the terminal rod 2X with the interlocking protrusions 2x can be smoothly inserted into the welding ring 45. The cut-out part 45S of the welding ring 45 can expand so that the interlocking ring part 45A can elastically deform. Thus, when the interlocking ring part passes the interlocking protrusions 2x, the central hole 45c will expand. It will be appreciated that the entire welding ring does not necessarily have a cut-out part that extends in a radial direction of the ring. The interlocking ring part may have a cut-out part that extends from the central hole of the interlocking ring part in a radial direction of the ring. As a result, the interlocking ring part can elastically deform so that the terminal rod with the interlocking protrusions can be inserted into the welding ring.

The stopper 47 shown in FIGS. 13 and 14 temporarily holds the welding ring 45 on the surface of the metal plate 3, when the terminal rod 2X is inserted into the welding ring 45. When the welding ring 45 is pushed toward the metal plate 3, the welding ring is temporarily held at the position where the outer peripheral edge 45Y of the outer periphery ring part 45C is brought in contact with the surface of the metal plate 3. After the terminal rod 2X is inserted into the welding ring so that the welding ring is held at the temporarily held position, the interlocking ring part 45A have passed the interlocking protrusions 2x so that the interlocking protrusion 2x is positioned on the upper surface of the interlocking ring part 45A in the Figure, that is, on the end side of the terminal rod 2 relative to the interlocking ring part. The interlocking protrusion 2x at this position interlocks with the interlocking ring part 45A so that the welding ring 45 is temporarily held whereby preventing the welding ring from moving outward. After that, the tight fitting ring part 45B is welded to the terminal rod 2X by irradiation of laser beam on the connection part between the inner peripheral surface of the insertion hole 6 of the tight fitting ring part 45B and the outer peripheral surface of the terminal rod 2X, and the outer periphery ring part 45C is welded to the metal plate 3 by irradiation of laser beam on the connection part between the outer peripheral edge 45Y of the outer periphery ring part 45C and the metal plate 3.

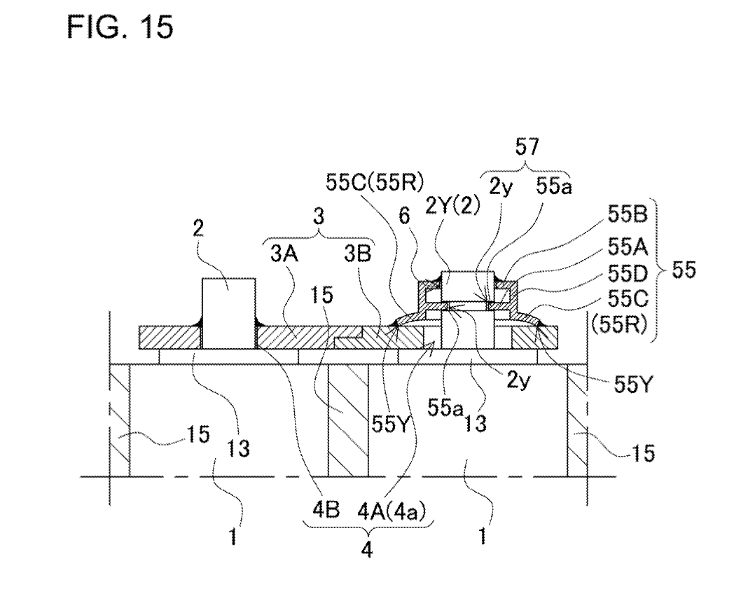

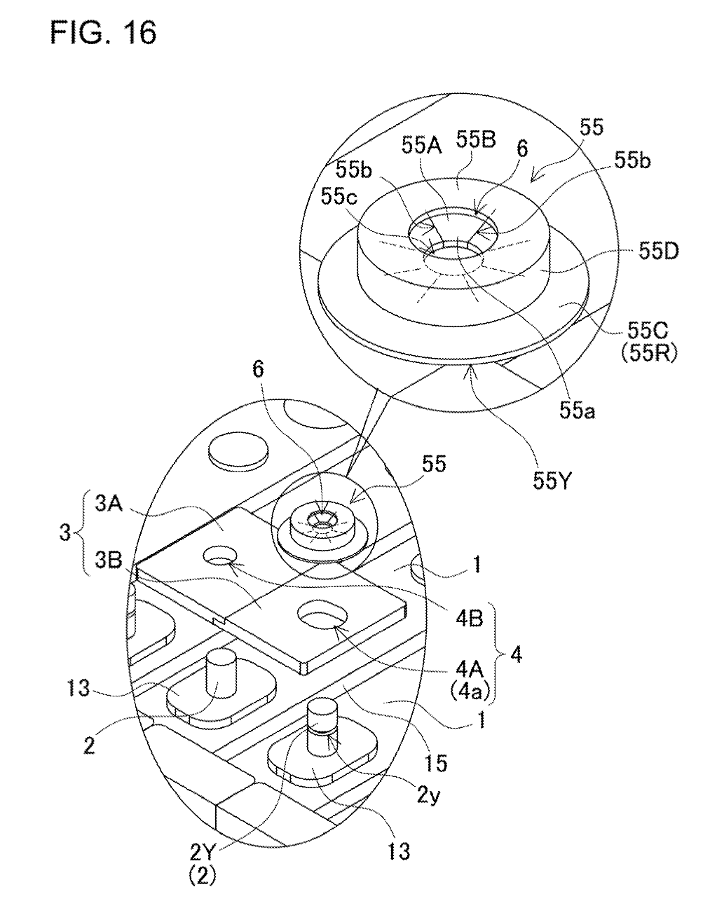

FIGS. 15 and 16 show a terminal rod 2Y and the welding ring 55. The terminal rod 2Y includes an interlocking recessed part 2y for forming the stopper 57. The interlocking ring part 55A includes elastic stopper parts 55a to be guided into the interlocking recessed part 2y. The illustrated interlocking recessed part 2y is a ring groove that extends in the circumferential direction on the surface of the terminal rod 2Y, and can interlock with the welding ring 55 at the temporarily held position. The interlocking recessed part 2y temporarily holds the welding ring 55 onto the terminal rod 2Y whereby preventing the welding ring from moving outward when the ends of the elastic stopper parts 55a of the interlocking ring part 55A are guided into the interlocking recessed part.

As shown in FIG. 16, the interior shape of a center hole 55c of the interlocking ring part 55A of the welding ring 55 is dimensioned smaller than the exterior shape of the terminal rod 2Y. The interlocking ring part has a plurality of cut lines 55b that extend from the central hole 55c toward the outer periphery of the interlocking ring part so that elastic stopper parts 55a are formed between the cut lines 55b. As shown in FIG. 15, when the terminal rod 2Y is inserted into the welding ring 55, the elastic stopper parts 55a are guided into the interlocking recessed part 2y as the ring groove so that the stopper 57 temporarily holds the welding ring 55 at the temporarily held position. When the welding ring is held at the temporarily held position, the outer peripheral edge 55Y of the outer periphery ring part 55C is brought in contact with the surface of the metal plate 3.

The illustrated welding ring 55 is formed of an elastically deformable metal plate. The welding ring includes a curved part 55R having the outer peripheral edge 55Y to be arranged close to the surface of the metal plate 3. The curved part 55R is arranged in the outer periphery ring part 55C of the illustrated welding ring 55. In this welding ring 55, when the terminal rod 2Y is inserted into the central hole 55c of the interlocking ring part 55A, the elastic stopper parts 55a and the curved part 55R elastically deform so that the elastic stopper parts 55a can be easily guided into the interlocking recessed part 2y. In addition, when the elastic stopper parts 55a interlock with the the interlocking recessed part 2y, in other words, when the welding ring 55 interlocks with the stopper 57 and is held at the predetermined position on the terminal rod 2Y, the outer peripheral edge 55Y of curved part 55R can be elastically pressed toward the surface of the metal plate 3. It will be appreciated that the welding ring does not necessarily include the curved part. The welding ring may have the cut-out part as shown in FIG. 14 so that the elastic stopper parts of the interlocking ring part can be guided into the interlocking recessed part when the cut-out part expands.

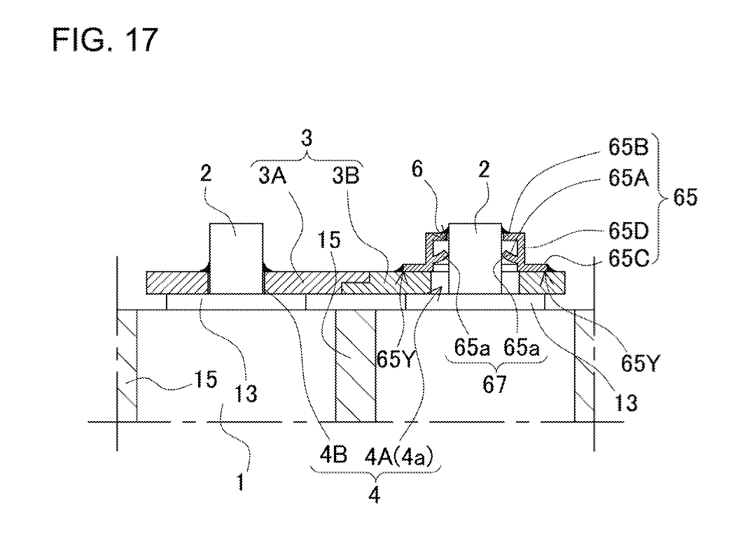

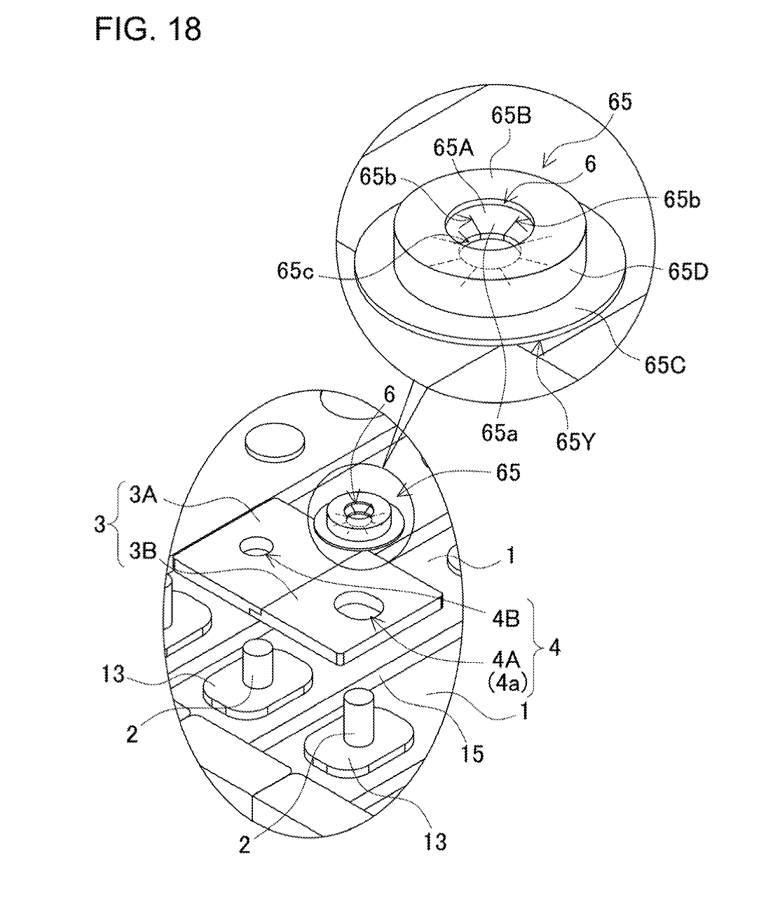

In FIGS. 17 and 18, the terminal rod 2 does not include the interlocking recessed part. The stopper 67 is constructed of only elastic stopper parts 65a that are provided in the interlocking ring part 65A of the welding ring 65. The interlocking ring 65 has a plurality of cut lines 65b that extend from a central hole 65c toward the outer periphery of the interlocking ring so that elastic stopper parts 65a are formed between the cut lines 65b. The elastic stopper parts 65a, which are provided in the interlocking ring part 65A, elastically engage with the surface of the terminal rod 2. Thus, the welding ring 65 is temporarily held on the terminal rod 2 whereby preventing the welding ring from moving outward.

The aforementioned stopper 57 or 67 temporarily holds the welding ring 55 or 65 on the surface of the metal plate 3, when the terminal rod 2 is inserted into the welding ring 55 or 65. When the welding ring 55 or 65 is pushed toward the metal plate 3, the welding ring is temporarily held at the position where the outer peripheral edge 55Y or 65Y of the outer periphery ring part 55C or 65C is brought in contact with the surface of the metal plate 3. When the welding ring is temporarily held at the temporarily held position, the elastic stopper parts 55a or 65a of the interlocking ring part 55A or 65A are guided into the interlocking recessed part 2y, alternatively, the elastic stopper parts elastically engage with the surface of the terminal rod 2 so that the welding ring 55 or 65 is temporarily held on the terminal rod 2. After that, the tight fitting ring part 55B or 65B is welded to the terminal rod 2 by irradiation of laser beam on the connection part between the inner peripheral surface of the insertion hole 6 of the tight fitting ring part 55B or 65B and the outer peripheral surface of the terminal rod 2, and the outer periphery ring part 55C or 65C is welded to the metal plate 3 by irradiation of laser beam on the connection part between the outer peripheral edge 55Y or 65Y of the outer periphery ring part 55C or 65C and the metal plate 3.

The metal plate 3 has at least two (i.e., a plurality of) through holes 4. The reason is that a plurality of terminal rods 2 are inserted into the through holes 4 of each metal plate so that at least two battery cells 1 are connected to each other in series or in parallel. In the case where the metal plate 3 connects two adjacent battery cells 1 in series or in parallel, the metal plate 3 has two through holes 4. The terminal rod 2 of one battery cell 1 is inserted into one through hole 4, while the terminal rod 2 of another battery cell 1 is inserted into another through hole 4 so that the adjacent battery cells 1 can be connected to each other. In the case where the terminal rod 2 is directly welded to the inner periphery of the through hole 4 of the metal plate 3 without using the welding ring, it is necessary to match the exterior shape of the terminal rod 2 with the interior shape of the through hole 4. The reason is that the terminal rod 2 and the through hole 4 are welded to each other by irradiation of laser beam on the connection part between the terminal rod and the through hole with the terminal rod and the through hole being in contact with each other without gap. In this case, it is necessary to accurately match the interval between the through holes 4 in the metal plate 3 with the interval between the adjacent battery cells 1. The reason is that, if the interval between the through holes 4 does not match with the interval between the terminal rods, the terminal rods 2 cannot be smoothly inserted into the through holes. However, it is difficult to mass-manufacture the battery cells 1 with accurate dimension of the exterior shape of the battery cell and the position of the terminal rods 2. For this reason, even if the through holes 4 are accurately positioned in the metal plate 3, the positions of the terminal rods 2 may be deviated since the battery cell 1 will have a dimensional deviation of the positions of the terminal rods.

In the case where the terminal rod 2 is welded to the metal plate 3 through the welding ring 5, 25, 35, 45, 55 or 65, even if the through hole 4 of the metal plate 3 is larger than the terminal rod 2, the terminal rod 2 can be welded to the metal plate 3. For this reason, in the case where the metal plate 3 has a plurality of through holes 4, if the interior shape of the through hole 4 is larger than the terminal rod 2, this through hole allows a dimensional deviation in the battery cell 1 when the terminal rods 2 are welded to the metal plate 3. It will be appreciated that, in the case where the metal plate 3 has a plurality of through holes 4, one through hole 4 serves a tight fitting through hole 4B having a shape that matches with the outer periphery of the terminal rod, while other through hole 4 serves as a loose fitting through hole 4A having a shape larger than the exterior shape of the terminal rod 2. The terminal rod 2 that is inserted into the tight fitting through hole 4B is directly welded and electrically connected to the metal plate 3. The illustrated terminal rod 2 that is inserted into the loose fitting through hole 4A is electrically connected to the metal plate 3 through the welding ring 5, 25, 35, 45, 55 or 65.

The loose fitting through hole 4A is an elongated hole 4a as shown in FIGS. 5 to 19, and allows a dimensional deviation in the longitudinal direction of the elongated hole 4a. The loose fitting through hole 4A as the elongated hole 4a extends in the longitudinal direction of the metal plate 3, and allows a dimensional deviation in the side-by-side arrangement direction of the rectangular battery cells 1 when the rectangular battery cells are arranged side by side.

The welding ring 5, 25, 35, 45, 55 or 65 is formed of a metal plate the material of which is same as the terminal rod 2 and the metal plate 3. The positive/negative terminal rods 2 of the lithium ion battery are formed of different metals. Accordingly, the welding rings 5, 35, 35, 45, 55 or 65 for connecting the positive/negative terminal rods 2 are formed of the different metals. The positive electrode of the lithium ion battery is formed of aluminum, while the negative electrode is formed of copper. Correspondingly, the welding ring for connecting the terminal rod of the positive electrode is formed of aluminum, while the welding ring for connecting the terminal rod of the negative electrode is formed of copper.

The both ends of the metal plate 3 are formed of different metals. Each of the ends of the metal plate 3 is connected to the corresponding terminal rod 2 that is formed of the same metal as this end of the metal plate. In the case where the metal plate 3 is connected to the battery cells 1 that includes the terminal rods 2 formed of copper and aluminum, the metal plate includes a first metal plate 3A that is formed of an aluminum plate, and a second metal plate 3B that is formed of a copper plate. The first and second metal plates 3A and 3B are coupled to each other with the plates being in tight contact with each other.

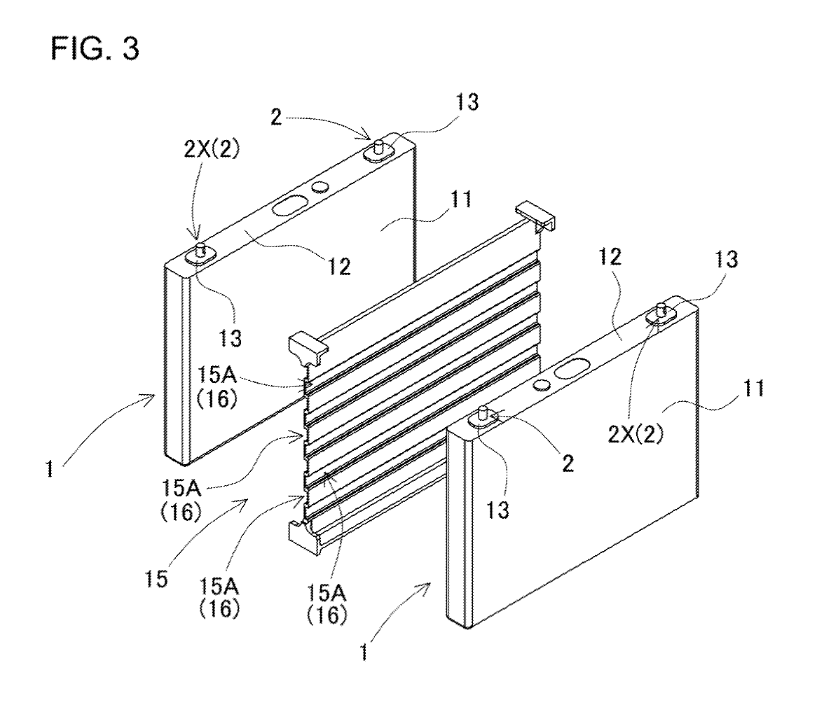

In the case where the exterior container 11 of the battery cell 1 is formed of metal, as shown in FIG. 3, an electrically insulating spacer 15 is sandwiched between the battery cells so that adjacent battery cells 1 are electrically insulated from each other. The electrically-insulating spacer 15 electrically insulates the exterior containers 11 of the adjacent battery cells 1 from each other. In addition to this, the electrically insulating spacer forms battery-cooling gaps 16 between the battery cells 1. To achieve this, the electrically-insulating spacer 15 is formed of an electrically-insulating material such as plastic by molding. The air-flowing grooves 15A are formed on both surfaces of the electrically-insulating spacer 15 so that the cooling gaps 16 are formed between the battery cells 1. The air-flowing groove 15A of the electrically-insulating spacer 15 horizontally extends. In other words, the both sides of the battery cell 1 are connected by the gas-flowing groove. Thus, air horizontally flows through the cooling gaps 16, which are formed on the electrically-insulating spacer 15 so that the battery cell 1 can be cooled.

The battery cells 1 are held in place by the fasteners 17 with the electrically-insulating spacers 15 being sandwiched between the battery cells, which are arranged side by side. The fasteners 17 include a pair of end plates 18, and the metal binding bar 19. The end plates are arranged on the both end surfaces of the battery assembly of the battery cells, which are arranged side by side. The ends of the binding bar 5 are coupled to the end plates 18 so that the battery cells 1 are arranged side by side and pressed from the both end surface sides of the battery assembly.

1. A battery system comprising:
a plurality of battery cells that include terminal rods;
metal plates that receive the terminal rods of said battery cell, and connect said battery cells to each other in series and/or in parallel; and
welding rings that are arranged on said metal plates, and have insertion holes into which said terminal rods are inserted, the inner peripheral surface of the insertion hole being welded to the terminal rod, and the outer periphery of the welding ring being welded to the metal plate with the terminal rod being inserted into said insertion hole,
wherein said terminal rods are electrically connected to said metal plates through said welding rings,
wherein said terminal rod and/or said welding ring includes a stopper that temporarily holds the welding ring at a predetermined position with the welding ring being connected to said terminal rod, and
wherein the temporarily held position of the stopper is the position where the outer periphery of the welding ring is brought in contact with the surface of the metal plate.

2. The battery system according to claim 1, wherein each of said metal plates has a plurality of through holes into which the terminal rods of the plurality of battery cells are inserted, wherein tight and loose fitting through holes are provided as said plurality of through holes, wherein the tight fitting through hole has a shape that matches with the outer periphery of the terminal rod, and the loose fitting through hole has a shape larger than the exterior shape of the terminal rod, wherein the terminal rod that is inserted into the tight fitting through hole is directly welded and electrically connected to the metal plate, and the terminal rod that is inserted into the loose fitting through hole is electrically connected to the metal plate through the welding ring.

3. The battery system according to claim 2, wherein each of said metal plates has one tight fitting through hole, and one or more loose fitting through holes.

4. The battery system according to claim 2, wherein said loose fitting through hole is an elongated hole.

5. The battery system according to claim 1, wherein said stopper is an interlocking protrusion that is arranged on and protrudes from the surface of said terminal rod, wherein said welding ring can be sandwiched between the metal plate and the interlocking protrusion so that the welding ring can be held at the predetermined position.

6. The battery system according to claim 1, wherein said welding ring includes an interlocking ring part into which the terminal rod is inserted, a tight fitting ring part that is coupled to the interlock ring part and arranged on the end side of the terminal rod relative to the interlock ring part, the tight fitting ring part having the insertion hole that matches with the terminal rod and is to be welded to the terminal rod, and an outer periphery ring part that is coupled to the tight fitting and interlock ring parts, the outer periphery of the outer periphery ring part being be welded to the metal plate.

7. The battery system according to claim 6, wherein said terminal rod includes the interlocking protrusion that interlocks with the interlocking ring part of said welding ring.

8. The battery system according to claim 6, wherein said terminal rod includes an interlocking recessed part that interlocks with the interlocking ring part of said welding ring.

9. The battery system according to claim 1, wherein said welding ring includes a curved part having an outer peripheral edge to be arranged close to the surface of the metal plate.

10. The battery system according to claim 9, wherein when said welding ring is held at the predetermined position on the terminal rod by the stopper, the outer peripheral edge of the curved part is elastically pressed toward the surface of the metal plate.

11. The battery system according to claim 1, wherein said welding ring has a cut-out part that extends in a radial direction of the ring.

12. The battery system according to claim 1, wherein the interior shape of the insertion hole of said welding ring is smaller than the exterior shape of the terminal rod, wherein said welding ring has a plurality of cut lines that extend from the insertion hole toward the outer periphery but do not reach the outer peripheral edge so that elastic parts are formed between the cut lines whereby forming the stopper, wherein when the terminal rod is inserted into the welding ring the elastic parts elastically engage with the surface of the terminal rod so that the welding ring is temporarily held at the temporarily held position on the terminal rod.
